(19) United States
(12) Patent Application Publication
(10) Pub. No.: US 2010/0171465 A1
(43) Pub. Date: Jul. 8, 2010

(54) Charging Station Configured To Provide Electrical Power to Electronic Devices And Method Therefor

(75) Inventors: Joshua Seal, Marina del Rey, CA (US); Kenneth Mori, Los Angeles, CA (US)

Correspondence Address: BRYAN CAVE LLP, TWO NORTH CENTRAL AVENUE, SUITE 2200, PHOENIX, AZ, 85004, US

(73) Assignee: BELKIN INTERNATIONAL, INC., Compton, CA (US)

(21) Appl. No.: 12/652,740

(22) Filed: Jan. 5, 2010

Related U.S. Application Data
(63) Continuation-in-part of application No. 12/636,360, filed on Dec. 11, 2009.
Application No. 12/636,360 is a continuation of application No. 11/147,676, filed on Jun. 8, 2005, now Pat. No. 7,652,452.

(51) Int. Cl. H02J 7/00; H02J 7/04

(52) U.S. Cl. 320/114; 320/137; 320/155

(57) ABSTRACT

Some embodiments disclose a charging station configured to provide electrical power to one or more portable electronic devices. The charging station can include: (a) at least one switch configured to turn-on and turn-off the charging station such that the charging station is not drawing any of the electrical power when the charging station is turned-off; (b) one or more output ports configured to supply the electrical power to the one or more portable electronic devices when the one or more portable electronic devices are electrically coupled to the one or more output ports and the charging station is turned-on; (c) one or more sensors electrically coupled to the one or more ports and configured to detect whether electrical power is being drawn by the one or more portable electronic devices through the one or more output ports; and (e) a controller module configured to turn-off the charging station using the at least one switch when the one or more sensors detect that the electrical power is not being drawn by the one or more portable electronic devices through the one or more output ports. Other embodiments are disclosed in this application.

### CROSS-REFERENCE TO RELATED APPLICATIONS

This is a continuation-in part application of U.S. application Ser. No. 12/636,360, filed Dec. 11, 2009, which is a continuation application of U.S. application Ser. No. 11/147,676 filed Jun. 8, 2005. U.S. application Ser. Nos. 12/636,360 and 11/147,676 are incorporated herein by reference.

### FIELD OF THE INVENTION

This invention relates generally to charging stations for charging and protecting portable electronic devices.

### BACKGROUND

Almost all of the increasing number of available portable electronic devices, including telephones, personal digital assistants (PDAs), digital cameras, mp3 players, and so forth, routinely depend upon batteries as a power source. For convenience and to ease battery replacement costs, rechargeable batteries have found wide utility in powering contemporary consumer and business products. For example, nickel cadmium batteries may be used to energize portable electronic devices and then repeatedly recharged and reused. Rechargeable batteries can be recharged by plugging an AC (alternating current) powered charger unit into the portable electronic device and into an AC power wall receptacle. The AC-powered charger unit typically converts 110 or 120 volt AC current from an outlet to low voltage DC power used to recharge the batteries. For example, portable electronic devices can include a universal serial bus (USB) connector, which plugs into a USB connector to charge the portable electronic device. Without some sort of management system, the number of electronic devices that need to be recharged can quickly become both unsightly and unwieldy.

The increase in the number of portable electronic devices has lead to the introduction of charging stations that provide a mechanism for charging rechargeable batteries. Such charging stations are convenient and useful, but are inadequate in that they only recharge certain types of devices, are difficult to use, do not incorporate a surge protector and are not multi-functional. Furthermore, these battery charging stations cannot be used to recharge the batteries of electronic device that are charged through USB connector.

Furthermore, charging stations and portable electronic devices can continue to consume electrical power even when switched off. Over an extended period of time, nominally off electronic devices can consume a significant amount of electrical power and substantially raise the electrical bill of the user. For example, portable electronic devices coupled to a charging station can continue to consume electrical power even after all of the portable electronic devices are fully charged and, thus, increase the electrical bill of the user.

In another situation, a person might forget to turn-off an electronic device when he is finished using the electronic device. For example, a person may forget to turn the charging station off after he has uncoupled the portable electronic devices from the charging station, and, consequently, the charging station continues to draw electrical power even though the charging station is idle.

Accordingly, there exists a need for a charging system that provides a mechanism for charging a variety of devices, increases the number of devices that can be charged at the same time and also holds other objects that do not need to be charged, such as a wallet or keys. Moreover, a need exists for an apparatus or system that allows a user to stop phantom electrical power usage by charging stations and electronic devices coupled to charging stations.

### SUMMARY OF EXAMPLES OF EMBODIMENTS

Accordingly, embodiments provide a charging station that overcomes the detriments of the prior art. For example, embodiments can be a multi-component charging station. The charging station can include a top removable tray for holding electronic devices, such as telephones, pagers, personal digital assistants (PDAs), wireless e-mail devices, digital cameras, mp3 players. The tray can also hold and the charging station can also power charging stations that are separate from the portable electronic devices. The tray of the multi-component charging station is substantially flat to receive and hold a variety of objects. In one preferred embodiment, the tray portion of the battery charging station has a raised perimeter wall to prevent objects placed on the tray from falling off. The charging station also includes a base that houses a surge protector having multiple AC outlets. The surge protector within the base can power multiple charger units at once and protect the units from surges or spikes in power. The base can be covered by a removable base cover. The base cover is particularly useful when the tray and base are positioned separately. For example, the tray holding the portable electronic devices and other small objects can be placed on a table, while the base is placed on the floor. Then, the base cover can be placed on top of the base to conceal the surge protector, outlets, and the charger units.

In another embodiment, the charging station contains an opening that leads to the interior space of the base. The opening can be located in the base cover, in the tray or in the base part. The opening permits at least one portable electronic device to be connected to its associated charger unit plugged into the surge protector within the interior space. In another preferred embodiment, a second opening is located within the charging station to permit the surge protector to be plugged into an external outlet.

In yet another embodiment, the opening located within the charging station is fitted with a grommet. In another preferred embodiment, the grommet has multiple openings that permit the cord from each charger unit to connect to its associated electronic device through one of the openings in the grommet and the opening in the charging station to the electronic device located on the tray.

In still another embodiment, the perimeter wall of the tray contains at least one indentation extending from the interior surface of the perimeter wall to the outer surface of the perimeter wall. Thus, when at least one electronic device is positioned on the tray, the cord from the charger unit can be routed to the electronic device through the indentation.

In another embodiment, the perimeter wall of the tray contains at least one indentation extending from the interior surface of the perimeter wall to an opening in the perimeter wall that leads to the surge protector and outlet within the interior space.

In another embodiment, the charging station is integrated as a universal serial bus (USB) hub.

In another embodiment, the charging station is integrated with a circuit breaker switch.

In another embodiment, the charging station is integrated with at least one additional outlet.

Many embodiments disclose a charging station configured to provide electrical power to one or more portable electronic devices. The charging station can include: (a) at least one switch configured to turn-on and turn-off the charging station such that the charging station is not drawing any of the electrical power when the charging station is turned-off; (b) one or more output ports configured to supply the electrical power to the one or more portable electronic devices when the one or more portable electronic devices are electrically coupled to the one or more output ports and the charging station is turned-on; (c) one or more sensors electrically coupled to the one or more ports and configured to detect whether the electrical power is being drawn by the one or more portable electronic devices through the one or more output ports; and (e) a controller module configured to turn-off the charging station using the at least one switch when the one or more sensors detect that the electrical power is not being drawn by the one or more portable electronic devices through the one or more output ports.

Various embodiments disclose a charge valet configured to charge two or more portable electronic devices. The charge valet can include: (a) an input power coupling configured to receive alternating current electrical power from one or more external electrical power sources; (b) one or more switches electrically coupled to the input power coupling such that the charge valet is not pulling any of the alternating current electrical power from the one or more external electrical power sources when the one or more switches is turned-off; (c) an electrical power converter electrically coupled to the one or more switches and configured to convert the alternating current electrical power to direct current electrical power; (d) one or more output power couplings electrically coupled to the electrical power converter and configured to provide the direct current electrical power to the two or more portable electronic devices; (e) one or more sensor units electrically coupled to the electrical power converter and the one or more output power couplings such that the one or more sensor units detect an electrical status of the one or more output power couplings; and (f) microprocessor electrically coupled to the one or more sensor units and the at least one of the one or more switches such that the microprocessor turns off at least one of the one or more switches based on the electrical status of the one or more output power couplings.

Additional embodiments disclose a method of providing electrical power to one or more portable electronic devices using a charging station when the one or more portable electronic devices are electrically coupled to one or more output ports of the charging station. The method can include one or more of: turning-on one or more switches to begin providing electrical power to the one or more output ports of the charging station; starting a timer to track a charging time; determining a connectivity status of the one or more output ports of the charging station; if the charging time is equal to or greater than a first predetermined amount of time, turning-off the at least one of the one or more switches such that the charging station is not using any electrical power; determining a change in the connectivity status of the one or more output ports of the charging station; if the change in the connectivity status of the one or more output ports of the charging station is that a new electronic device of the one or more portable electronic devices has been coupled to one of the one or more output ports of the charging station, resetting the charging time; and if the change in the connectivity status of the one or more output ports of the charging station is that all of the one or more portable electronic devices have been uncoupled from the one or more output ports of the charging station, turning-off at least one of the one or more switches such that the charging station is not using any electrical power.

### BRIEF DESCRIPTION OF THE DRAWINGS

The invention will be better understood from a reading of the following detailed description, taken in conjunction with the accompanying figures in the drawings in which:

FIG. 1 is an illustration of a charging station positioned on a table according to a first embodiment;

FIG. 2 is an illustration of a base of the charging station according to the first embodiment;

FIG. 3 is an illustration of the base and a base cover of the charging station according to the first embodiment;

FIG. 4 is an illustration of a charging station with an external outlet according to a second embodiment;

FIG. 5 is an illustration of a tray of a charging station, according to a third embodiment;

FIG. 6 is an illustration of a base and a tray of a charging station, according to a fourth embodiment;

FIG. 7 illustrates a top, back, right isometric view of a charging station, according to a fifth embodiment;

FIG. 8 illustrates a back view of the charging station of FIG. 7, according to the fifth embodiment;

FIG. 9 illustrates a front view of the charging station of FIG. 7, according to the fifth embodiment;

FIG. 10 illustrates a left view of the charging station of FIG. 7, according to the fifth embodiment;

FIG. 11 illustrates a right view of the charging station of FIG. 7, according to the fifth embodiment;

FIG. 12 illustrates an example of a block diagram of the circuitry of the charging station of FIG. 7, according to the fifth embodiment;

FIG. 13 illustrates an example of a first portion of the circuitry of the charging station of FIG. 7, according to the fifth embodiment;

FIG. 14 illustrates an example of a second portion of the circuitry of the charging station of FIG. 7, according to the fifth embodiment; and

FIG. 15 illustrates a flow chart for an embodiment of a method of providing electrical power to one or more electronic devices using a charging station when the one or more electronic devices are electrically coupled to one or more output ports of the charging station, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF THE DRAWINGS

The multi-component charging station can allow a plurality of rechargeable portable electronic devices to be connected to AC-powered charger units for recharging either individually or simultaneously by placing the electronic devices on the tray of the multi-component charging station. The charger unit cord for each portable electronic device is then fed through at least one opening within the charging station from an AC outlet protected by a surge protector within the interior space of the charging station to the associated portable electronic device. These portable electronic devices include, but are not limited to mobile phones, personal digital assistants (PDAs), digital cameras, “Moving Pictures Experts Group-1 (MPEG-1) Audio Layer 3” (mp3) players, CD players, cassette players, pagers, walkie talkies, gaming systems, and other rechargeable electronic devices. Because of the open tray feature, embodiments of the present invention allow multiple electronic devices to be recharged or stored simultaneously and virtually any type of portable electronic device can be recharged. Further, embodiments of the charging station allow for the storage of other small objects that do not need to be recharged, such a wallet or keys.

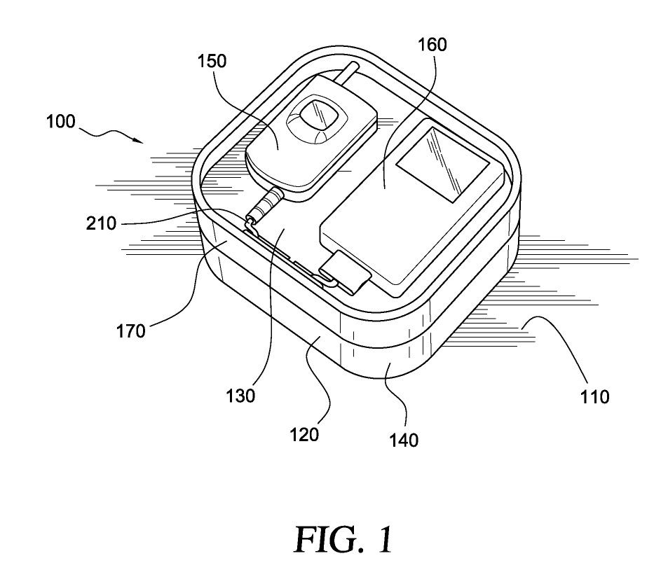

Referring now to the figures, FIG. 1 is a top view of a charging station 100 according to a first embodiment. Charging station 100 can be positioned on top of a surface 110, such as a table. As illustrated in FIG. 1, charging station 100 has multi-components. In FIG. 1 the tray 130 is placed on top of the base 140. Although not visible in FIG. 1, a base cover 190 can also be placed between the tray 130 and the base 140. The tray 130 is capable of storing portable electronic devices, including, for example, a mobile telephone 150 and an mp3 player 160. In one preferred embodiment, the tray 130 has a raised perimeter wall 170 that prevents objects that are positioned on the tray 130 from falling off.

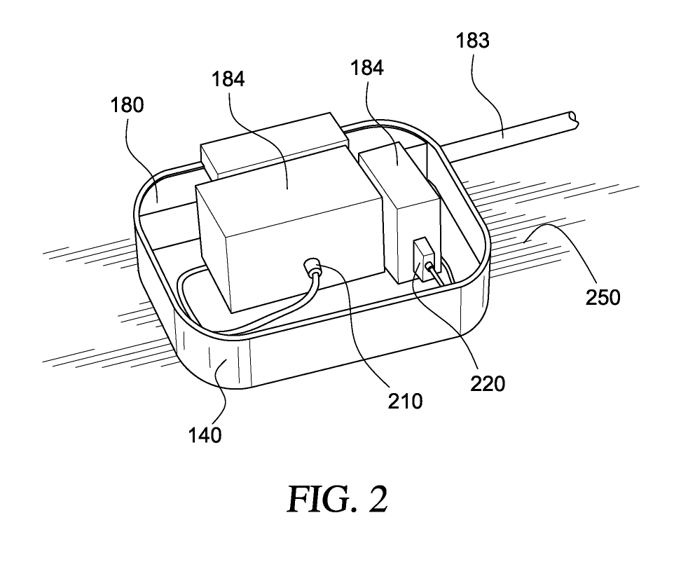

FIG. 2 is an illustration of the base 140 of the charging station 100, according to the first embodiment. The base 140 houses a surge protector 180 which is powered by AC power provided from a 110 or 120 volt outlet 182 through a power cord 183. The surge protector 180 can provide power through multiple outlets 182 in the base. Each outlet 182 is capable of receiving a charger unit 184. Thus, the charging station 100 can charge multiple devices at once and protects the devices from surges or spikes in power. In some embodiments, the outlets 182 are sufficiently spaced apart to accept AC adaptor blocks. In other embodiments, the outlets 182 are repositionable via a short pigtail cord to accept AC adaptor blocks.

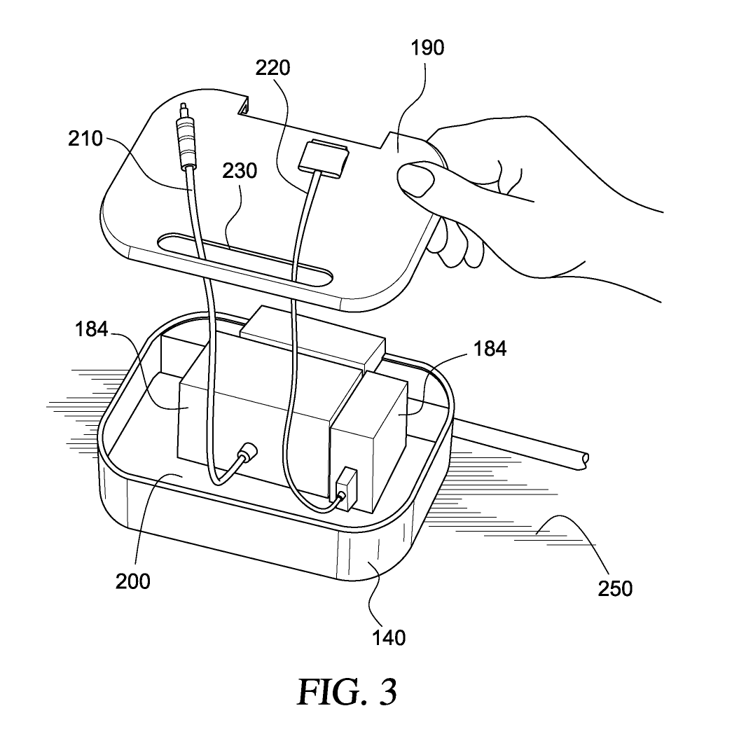

FIG. 3 is an illustration of the base 140 and base cover 190, according to the first embodiment. As illustrated in FIG. 3, a base cover can be placed on top of the base to enclose an interior space 200 and conceal the surge protector 180.

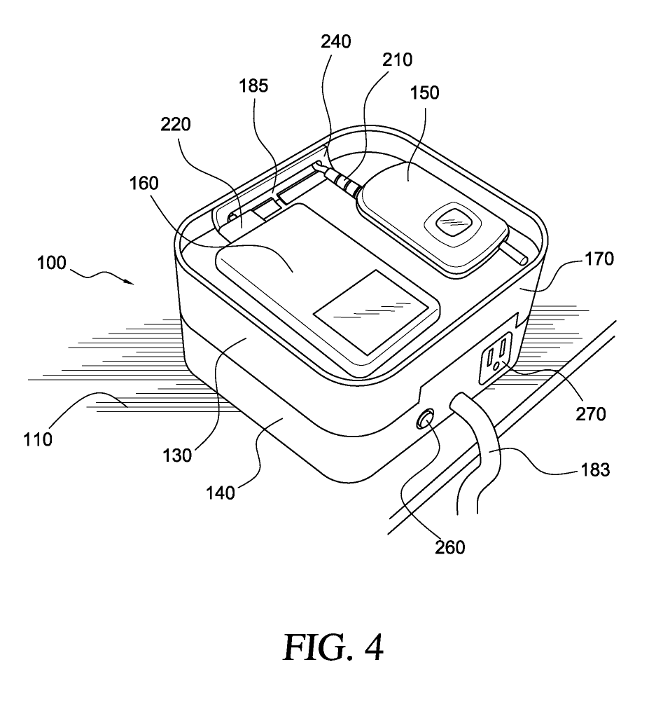

FIG. 4 is an illustration of the charging station 100, according to a second embodiment. As illustrated in FIG. 4, the tray 130 and preferably the perimeter wall 170 of the tray 130 has a first opening 185. The first opening 185 permits the charger cord for at least one portable electronic device, for example, as illustrated in FIG. 4, the mobile phone charger cord 210 and mp3 charger cord 220 to be fed through the first opening 185 from the interior space 200 within the base 140 where the charger unit 184 is connected to the surge protector 180. As illustrated by FIG. 3, there can be a second opening 230 in the base cover 190. When the removable base cover 190 is placed on top of the base 140, the second opening 230 allows charger cords, for example, the mobile phone charger cord 210 and mp3 charger cord 220, to be fed through the second opening from the interior space 200 within the base 140 where the charger units 184 are connected to the surge protector 180.

As illustrated in FIG. 4, a grommet 240 can be inserted into the first opening 185. The grommet 240 can be used to provide support for the charger cords, for example, the mobile phone charger cord 210 and mp3 charger cord 220 illustrated in FIG. 4, so that the mobile phone charger cord 210 and mp3 charger cord 220 can easily fit through the first opening 185. Further, the grommet 240 can also serve as a decorative feature. In one preferred embodiment, the grommet 240 can have multiple openings. Each opening can serve to permit access of one charger cord from the interior space 200 within the base 140 to the tray. A second grommet can also be utilized for the second opening 230 within the base cover 190. Such a second grommet is particularly useful if the base cover 190 is being utilized and will not be covered by the tray 130.

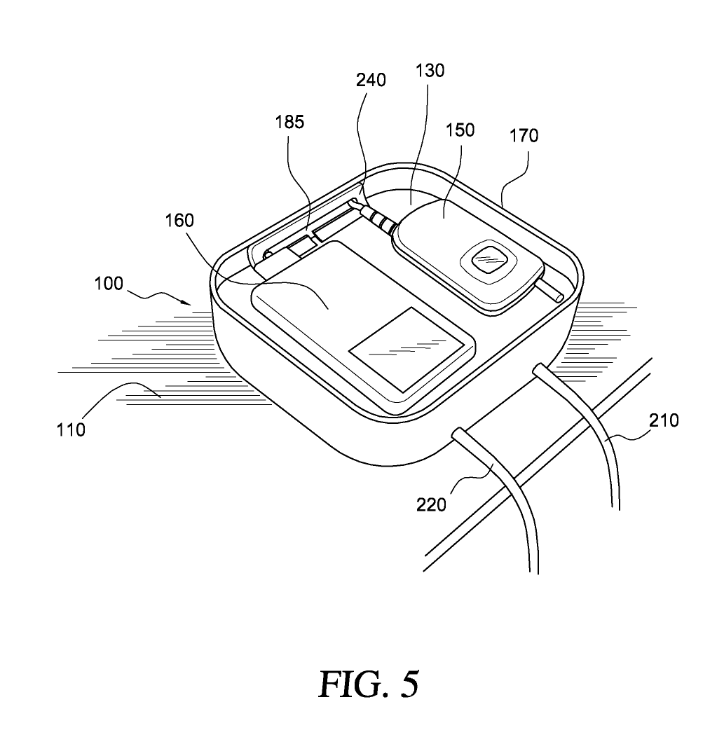

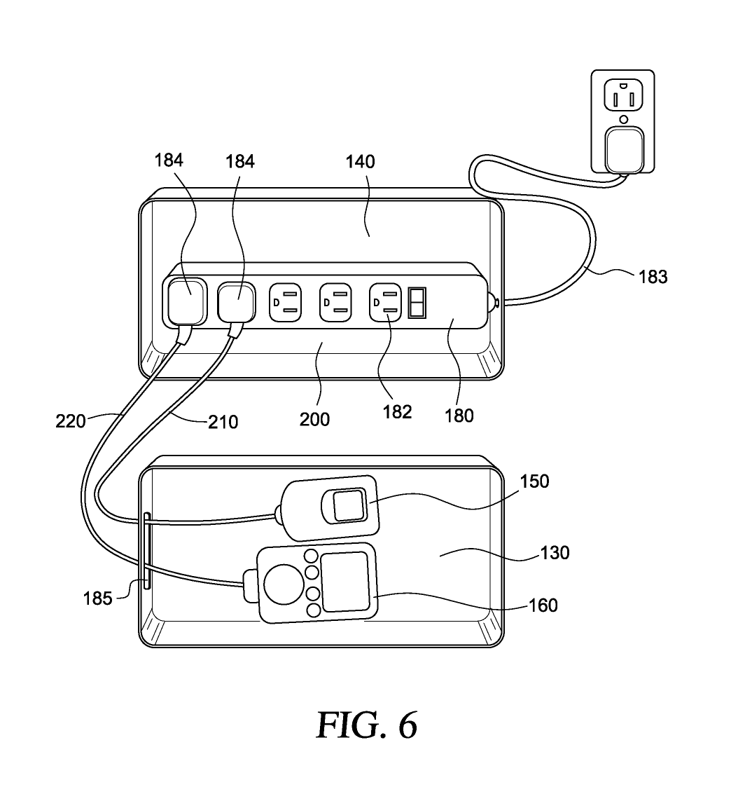

FIG. 5 and FIG. 6 are illustrations of the tray 130 of an unassembled charging station 100, according to the third and fourth embodiments, respectively. One of the benefits of these embodiments is the multi-component aspect to the charging station 100. The tray 130 portion of the charging station 100 can be used separately from the remainder of the charging station 100, specifically the base 140 and if desired, the base cover 190. For example, the tray 130 holding at least one portable electronic device, as illustrated in FIG. 5, the mobile telephone 150 and mp3 player 160, can be placed on a surface 110, such as a table, while the base 140, as illustrated in FIG. 2, is positioned on a second surface 250, such as the floor. If the charging station 100 is used in this manner, the charger cords, as illustrated in FIG. 5, will run from the tray through the first opening 185 off the surface 110 toward the second surface 250 to the base 140 that is positioned on the second surface 250. In this embodiment, the base cover 190 can be particularly useful when the tray 130 and base 140 are located on separate surfaces. The base cover 190 can be used on top of the base 140 to hide the surge protector 180 and charger units 184. Of course, if it is desired that the tray 130 or base 140 be placed on other surfaces, other than a table or floor, or other locations on the same surface, the multi-functional aspect to the disclosed embodiments permits such flexibility.

In many embodiments, the base cover 190 can be affixed to the base 140 using a closure mechanism, including but not limited to resilient interference means or a locking mechanism. In another preferred embodiment, the tray 130 can be affixed to the base 140 or base cover 190 using a closure mechanism, including but not limited to resilient interference means or a locking mechanism.

In yet another embodiment, the perimeter wall 170 of the tray contains at least one indentation that runs from the inner surface of the perimeter wall 170 to the outer surface of the perimeter wall 170. When at least one electronic device is placed on the tray 130, the charger cord from the electronic device can be placed within the indentation.

In still another embodiment, the perimeter wall 170 contains at least one indentation that runs from the inner surface of the perimeter wall 170 to an opening in the perimeter wall 170. When at least one electronic device is placed on the tray 130, the charger cord from the electronic device can extend from the interior space in the base 140, to the opening, along the indentation to the top of the tray 130.

In yet other embodiments, the charging station 100 can be integrated with additional features such as with a USB hub, a circuit breaker switch 260 (FIG. 4), and/or at least one additional outlet 270 (FIG. 4) accessible from the exterior of the base to permit other electronic devices to be powered.

Charging station 100 eliminates the need for multiple charging stations or modules. The charging station 100 and other embodiments described herein can provide a distinct advantage over prior art systems because it is designed to be used with a plurality of portable electronic devices or battery charging units and is not limited to being used with a specific electronic device or battery charging units. Because of the structure of the charging station 100 (and other embodiments described herein) and particularly the tray 130, a plurality of portable electronic devices, regardless of size or shape, can be simultaneously or individually, stored and recharged.

Thus, in one aspect, the present embodiment provides a charging station for receiving a portable electronic device and a charger unit for charging a portable electronic device. The charging station comprises a base, a generally planar base cover, and a tray. The base comprises a generally planar bottom surface bounded by a perimeter wall. The base cover is removably attached to the upper portion of the perimeter wall of the base to enclose an interior space for housing a surge protector and a charger unit powered by the surge protector. The base cover also has an opening to permit a charger cord extending from a charger unit located within the interior space to pass through the base cover. The tray comprises a generally planar surface for receiving at least one portable electronic device. The tray is configured for removable attachment to the upper surface of the base cover. The tray also has an opening to permit a charger cord to pass through the tray. A surge protector is located within the interior space comprising outlets for providing regulated power to a charger unit for charging a portable electronic device.

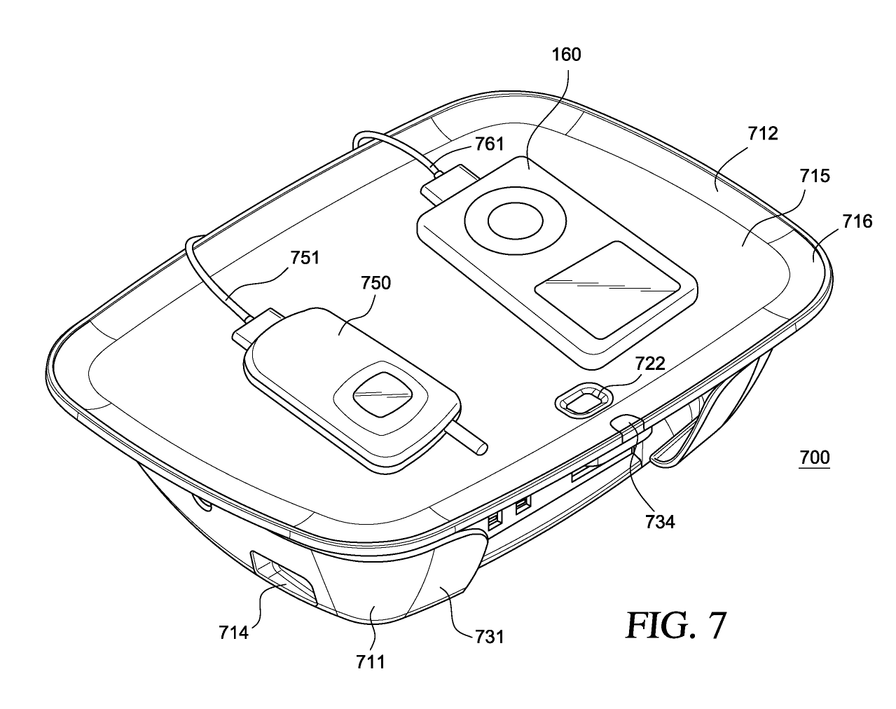

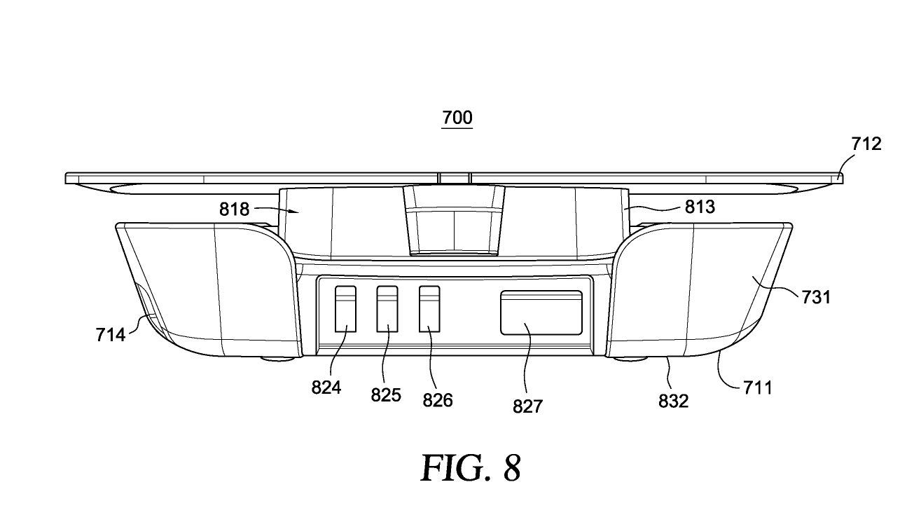

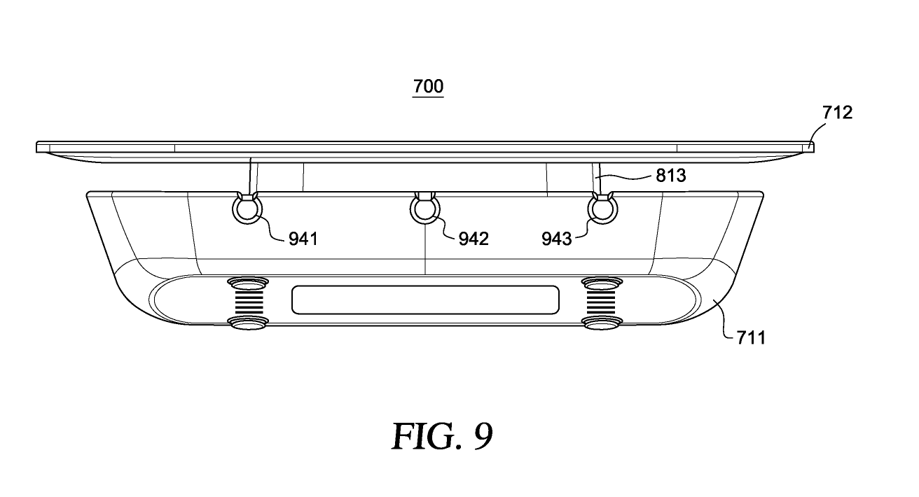

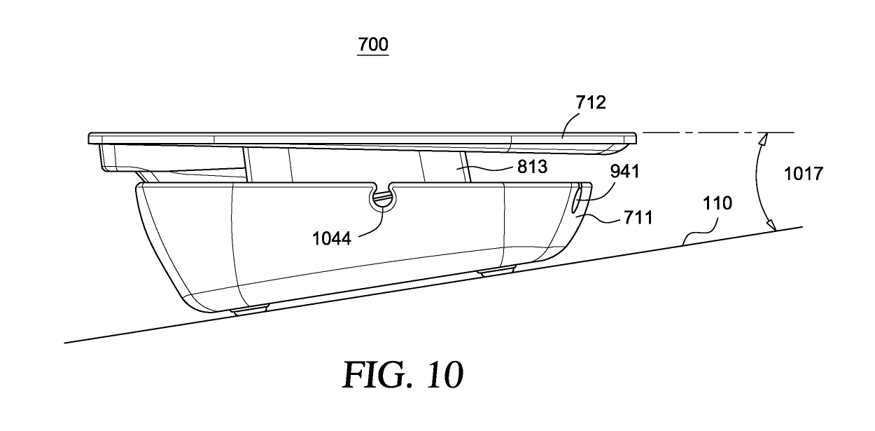

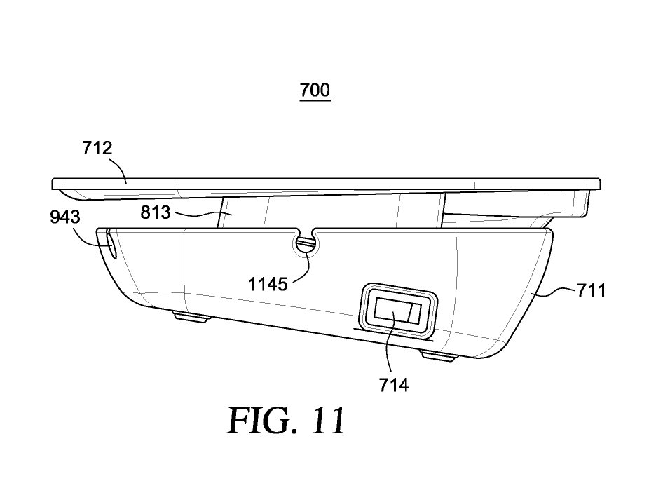

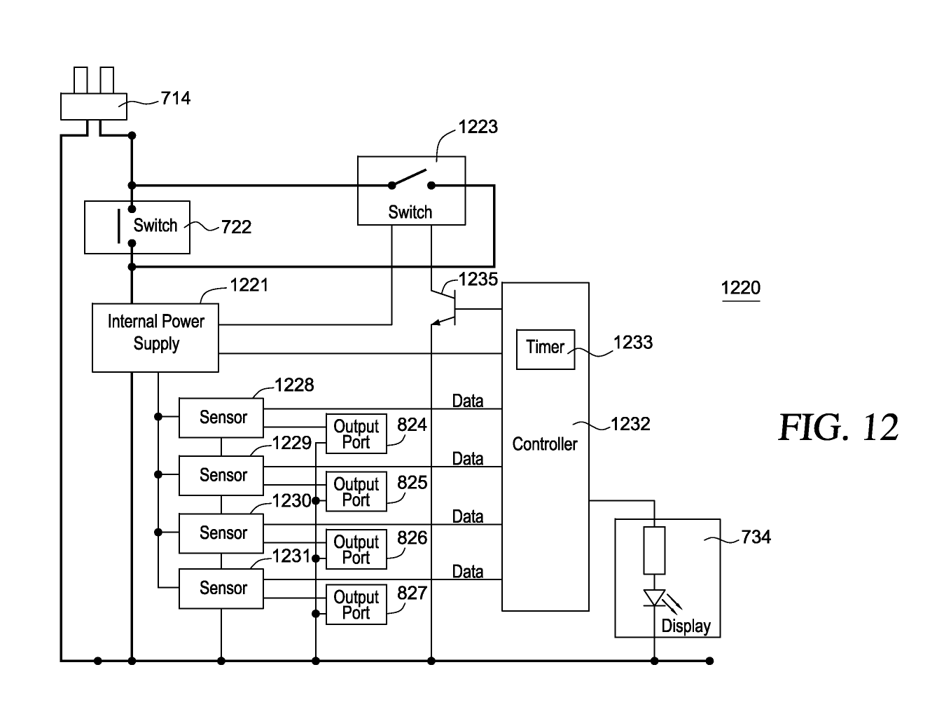

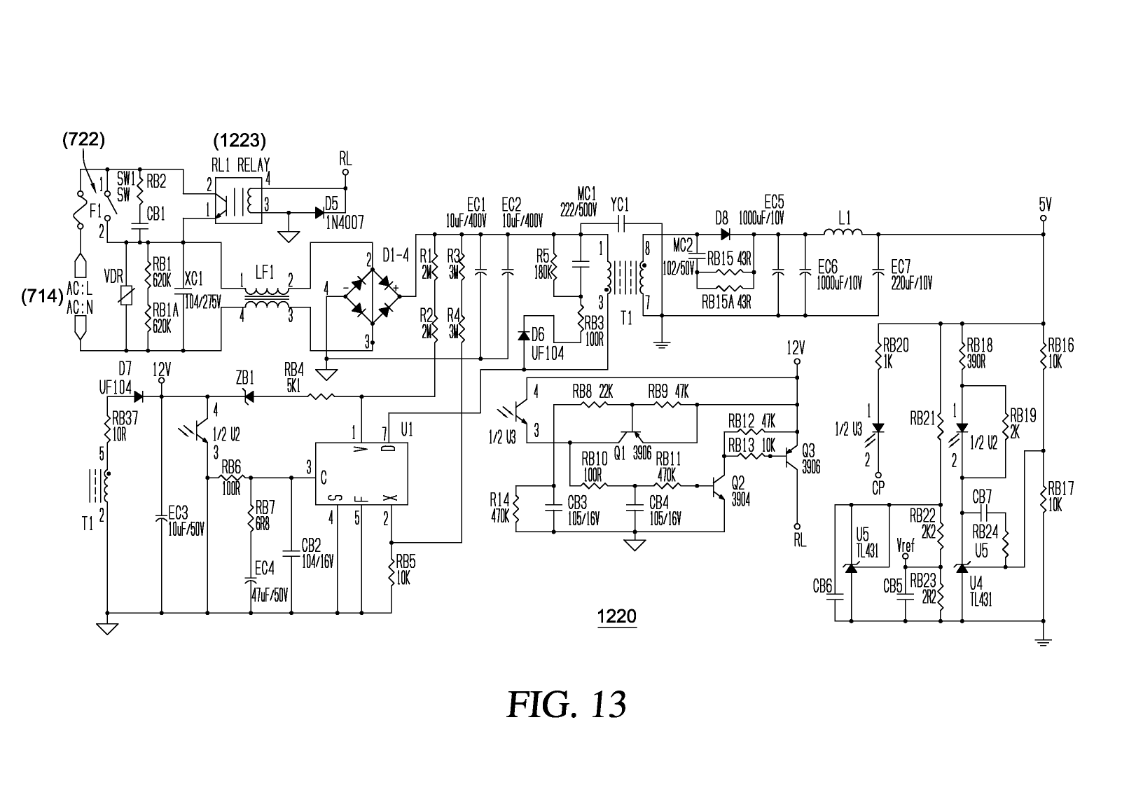

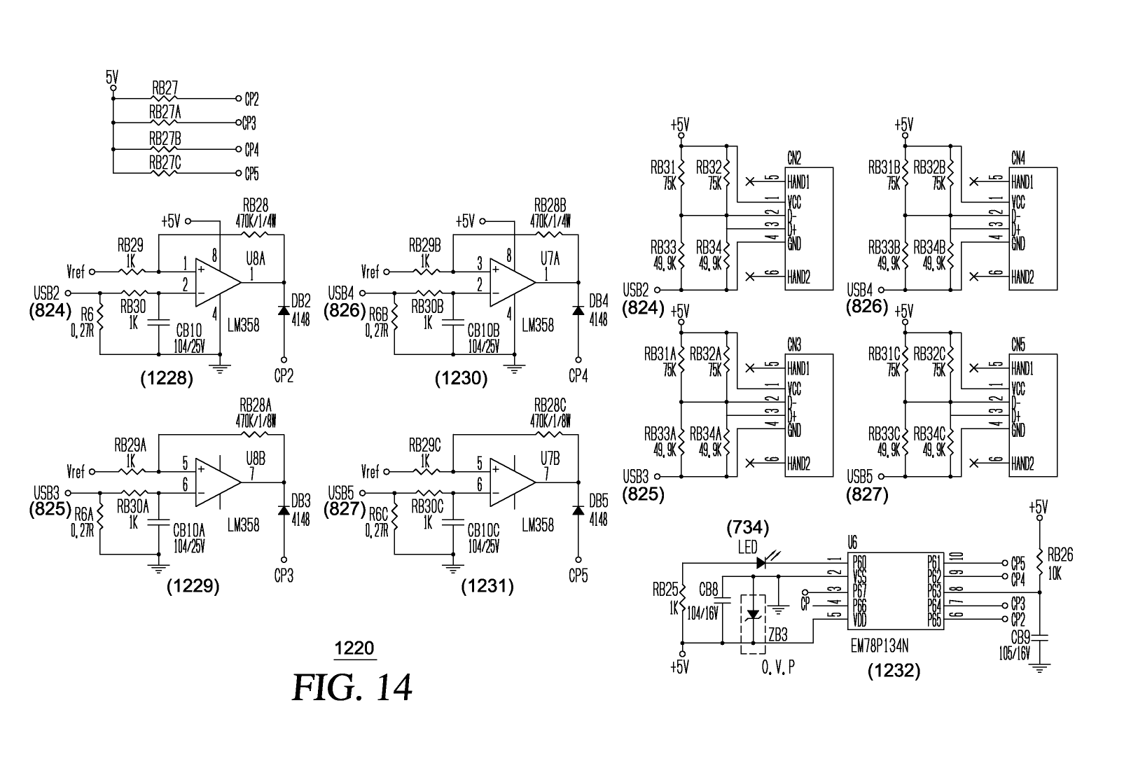

Turning to another embodiment, FIG. 7 illustrates a top, back, right isometric view of a charging station 700, according to a fifth embodiment. FIG. 8 illustrates a back view of charging station 700, according to the fifth embodiment. FIG. 9 illustrates a front view of charging station 700, according to the fifth embodiment. FIG. 10 illustrates a left view of charging station 700, according to the fifth embodiment. FIG. 11 illustrates a right view of charging station 700, according to the fifth embodiment. FIG. 12 illustrates an example of a block diagram of the circuitry of charging station 700, according to the fifth embodiment. FIG. 13 illustrates an example of a first portion of the circuitry of charging station 700, according to the fifth embodiment. FIG. 14 illustrates an example of a second portion of the circuitry of charging station 700, according to the fifth embodiment. Similar to the previous embodiments of a charging station, charging station 700 is merely exemplary and is not limited to the embodiments presented herein. Charging station 700 can be employed in many different embodiments or examples not specifically depicted or described herein.

In some embodiments, charging valet or charging station 700 can be configured to charge or provide electrical power to one or more portable electronic devices. Charging station 700 can include: (a) a base 711; (b) a tray 712; (c) a coupling region 813 (FIG. 8); and (d) circuitry 1220 (FIGS. 12, 13, and 14). In some examples, base 711, tray 712, and/or coupling region 813 can be made from plastic (e.g., acrylonitrile butadiene styrene).

In some examples, circuitry 1220 in FIG. 12 can include: (a) an input power coupling or input connector 714 (FIGS. 7 and 12); (b) an electrical power converter or internal power supply 1221; (c) one or more switches 722 and 1223 (FIGS. 7 and 12); (d) one or more output ports 824, 825, 826, and 827 (FIGS. 8 and 12); (e) one or more sensor units or sensors 1228, 1229, 1230, and 1231 (FIG. 12); (f) a controller 1232; (g) a timer 1233; and (h) a display 734.

In some examples, tray 712 is coupled to base 711 by coupling region 813, as shown in FIGS. 8-11. Base 711 can be configured to be positioned or rest on a surface 110 (FIG. 10), such as a table or desk. In some examples, input connector 714 and output ports 824, 825, 826, and 827 can be located at base 711. In other examples, input connector 714 and output ports 824, 825, 826, and 827 can be located at tray 712 and/or coupling region 813. Additionally, in some examples, at least a portion of circuitry 1220 is located in a cavity of coupling region 813. In the same or different embodiments, at least a portion of circuitry 1220 is located inside base 711 and/or tray 712.

Similar to tray 130 (FIG. 1), tray 712 can be designed to store portable electronic devices, including, for example, mobile telephone 750 and mp3 player 160. Tray 712 can include a generally planar surface 715 for receiving the one or more portable electronic devices (e.g., mobile telephone 750 and mp3 player 160). In many examples, tray 712 can have a raised perimeter wall 716 that prevents objects that are positioned on tray 712 from falling off. In the example illustrated in FIGS. 7-11, tray 712 is coupled to coupling region 813 such that tray 712 forms an angle 1017 (FIG. 10) with surface 110 (FIG. 10). In some examples, angle 1017 allows easier viewing of the portable electronic device positioned on tray 712. Angle 1017 is small enough such that the electronic devices are not pulled off of tray 712 by gravity. For example, angle 1017 can be approximately equal to twenty degrees or can be between ten and thirty degrees.

Coupling region 813 can include exterior surface 818 (FIG. 8) and a cavity (not shown). In the example illustrated in FIG. 7-11, a length and a width of coupling region 813 can be smaller than the lengths and the widths of base 711 and tray 712. In one example, the length and the width of coupling region 813 can be approximately half the length and the width, respectively, of tray 712. In the same or different example, the length and the width of coupling region 813 can be sixty percent of the length and the width, respectively, of base 711.

In some embodiments, coupling region 813 can be configured such that one or more charger cords (e.g., charger cords 751 and 761) can be wrapped around exterior surface 818. In these embodiments, the wrapping of the charger cords around coupling region 813 provides a convenient place to store excess charger cord when an electronic device is coupled to charging station 700 using the charger cord.

Additionally, base 711 can include a lip 731 that extends from an outer edge of a bottom surface 832 (FIG. 8) of base 711 towards tray 712. In some examples, lip 731 can at least partially hide from view the portion of the charger cord wrapped around coupling region 813.

In some embodiments, base 711 can also include one or more grommets 941, 942, 943, 1044, and 1145 in lip 731, as shown in FIGS. 9-11. Grommets 941, 942, 943, 1044, and 1145 can be configured to hold a portion of the charger cords of electronic devices coupled to charging station 700. For example, when mobile telephone 750 is coupled to charging station 700 and a first portion of charge cord 751 is wrapped around exterior surface 818 of coupling region 813, one or more second portions of charge cord 751 can be placed in one or more of grommets 941, 942, 943, 1044 and 1145. In some embodiments, placing the second portion of a charger cord in one or more of grommets 941, 942, 943, 1044 and 1145 keeps the first portion of the charger cord wrapped around coupling region 813.

Input connector 714 (FIGS. 7 and 12) can be configured to receive electrical power from one or more external power sources. In various embodiments, input connector 714 can be configured to receive alternating current (AC) electrical power from one or more external electrical power sources. In some embodiments, input connector 714 can be similar or identical to power cord 183 (FIGS. 2, 4, and 6), and the external power source can be similar or identical to 110 or 120 volt AC outlet 182 (FIGS. 2, 4, and 6). For example, input connector 714 can include a cable coupled to circuitry 1220 at one end and having an IEC (International Electrotechnical Commission) C7 connector at the other end of the cable. In other embodiments, input connector 714 can receive direct current (DC) electrical power. For example, input connector 714 can be a cigarette lighter adapter that is configured to receive DC electrical power from a cigarette lighter of a vehicle. The amount of electrical power drawn in by input connector 714 and output by output ports 824, 825, 826, and 827 can vary depending on, among other things, the status of the one or more portable electronic devices, as explained below.

In some examples, input connector 714 can be electrically coupled to one or more switches 722 and 1223 (FIGS. 7 and 12). Switch 722 can be electrically coupled in parallel with switch 1223. In some examples, switches 722 and 1223 can be further electrically coupled to an input of internal power supply 1221. Switch 1223 can also be coupled to controller 1232 through transistor 1235. Switch 722 and/or 1223 can be rated for 150 or 250 volts alternating current.

Switches 722 and 1223 can be configured to turn-on and turn-off charging station 700 such that charging station 700 (including switches 722 and 1223) is not drawing any electrical power when charging station 700 is turned-off. That is, switches 722 and 1223 can be electrically coupled to input connector 714 such that charging station 700 is not pulling any AC electrical power from the external electrical power sources when switches 722 and 1223 are turned-off. Switch 722 can be a physical switch used by a person to turn-on charging station 700. Switch 1223 can be used by controller 1232 to turn-on and turn-off charging station 700.

In some embodiments, switch 722 can be a non-latching switch (e.g., a micro switch, a snap-action switch, or a push switch). That is, switch 722 allows electricity to flow between its two contacts only when the contacts are held together by a user. When the non-latching switch is released by the user, the contacts are no longer in contact and the switch is turned-off.

Switch 1223, however, can be a latching switch. A latching switch is a switch that maintains its state (i.e., it remains turned-on or turned-off) after being activated. For example, switch 1223 can be a relay that uses an electromagnet to pull the switch closed when electrical power is applied to the relay. When the relay stops receiving electrical power (i.e., it receives instructions to turn-off), the relay can return to its default open position. In other examples, other types of latching switch can be used for switch 1223.

When switch 722 is a non-latching switch and switch 1223 is a latching switch, a user can push switch 722 to turn-on charging station 700. While the user is holding down switch 722, electrical power flows through switch 722 into the rest of circuitry 1220 including internal power supply 1221. Internal power supply 1221 initiates controller 1232 and controller 1232 turns on switch 1223. When the user releases switch 722, switch 722 is opened, but electricity continues to flow through switch 1223 to the rest of circuitry 1220.

When controller 1232 detects a predetermined condition to turn-off charging station 700 (i.e., a predetermined time period has passed or no electronic devices are coupled to output ports 824, 825, 826, or 827), controller 1232 opens switch 1223, and electrical power does not flow to the rest of circuitry 1220. In many embodiments, switches 722 and 1223 draw no electrical power when they are open. Accordingly, charging station 700 does not draw any electrical power when turned-off.

In other examples, charging station 700 can include a single switch. In still further examples, charging station 700 can include three or more switches. For example, a charging station can include a combination of switches that allows the user to turn-off charging station 700 using a switch. In the example shown in FIG. 12, a user can turn-on charging station 700 using switch 722, but can only turn-off charging station 700 by uncoupling all electronic devices from charging station 700 or disconnecting input connector 714 from the external power source.

Internal power supply 1221 can be configured to convert AC electrical power received from input connector 714 into DC electrical power. In some examples, internal power supply 1221 can be electrically coupled to and provide DC power to output ports 824, 825, 826, and 827. In some examples, internal power supply 1221 can provide electrical power at five volts to each of output ports 824, 825, 826, and 827. In some examples, internal power supply 1221 is electrically coupled to one or more output ports 824, 825, 826, and 827 through sensors 1228, 1229, 1230, and 1231, respectively. Internal power supply 1221 can also provide DC electrical power to switch 1223, controller 1232, display 734, and sensors 1228, 1229, 1230, and 1231. In other examples, internal power supply 1221 can convert DC electrical power to AC electrical power. In still other examples, the charging station does not include an internal power supply.

Output ports 824, 825, 826, and 827 are configured to supply electrical power (e.g., DC electrical power) to one or more portable electronic devices when the electronic devices are electrically coupled to the one or more output ports and charging station 700 is turned-on. In various embodiments, output ports 824, 825, 826, and 827 can supply 500 milliamperes of current at five volts.

In some examples, output ports 824, 825, 826, and 827 are universal serial bus ports. In other examples, output ports 824, 825, 826, and 827 are two-prong or three-prong electrical AC power outlets. In still other examples, output ports 824, 825, 826, and 827 can be another type of electrical power connector and/or a combination of different types of electrical power connectors. In various embodiments, charging station 700 can also include a surge protector.

Sensors 1228, 1229, 1230, and 1231 can be configured to detect whether electrical power is being drawn by portable electronic devices electrically coupled to output ports 824, 825, 826, and 827, respectively. That is, sensors 1228, 1229, 1230, and 1231 are electrically coupled to controller 1232 and output ports 824, 825, 826, and 827 such that sensors 1228, 1229, 1230, and 1231 can detect the electrical status of output ports 824, 825, 826, and 827, respectively. For example, each of the one or more sensors 1228, 1229, 1230, and 1231 can be configured to detect the following electrical statuses: (a) no-power drawings status; (b) an active-power drawing status; and/or (c) no-device connected status. In the no-power drawings status, the electronic device coupled to the output port is not drawing any electrical power from charging station 700. In the active-power drawings status, the electronic device coupled to the output port is drawing electrical power from charging station 700. In the no-device connected status, no electronic device is electrically coupled to the output port. Sensors 1228, 1229, 1230, and 1231 can communicate the status of each of the output ports to controller 1232.

In some examples, sensors 1228, 1229, 1230, and 1231 measure whether the electrical current being drawn by an output port is above or below a predetermined threshold. If the electrical power being drawn by an electronic device is below the predetermined threshold, the electrical status of the output port is considered to be in a no-power drawing or no-device connected status. If the electrical power being drawn by an electronic device is above the predetermined threshold, the output is considered to be in an active-power drawing status. In other examples, each of sensors 1228, 1229, 1230, and 1231 measure the actual current being drawn by an output port. In these examples, the current measurement is provided to controller 1232 and microcontroller can determine the status of each port.

Furthermore, sensors 1228, 1229, 1230, and 1231 are configured to detect when a new electronic device is coupled to one of output ports 824, 825, 826, and 827, respectively. That is, sensors 1228, 1229, 1230, and 1231 can detect when an output port transfers from a no-device connected state to an active-power drawing state. In various examples, each of the one or more sensors can include: (a) a sensing resistor; and (b) n operational amplifier electrically coupled to the sensing resistor.

Controller 1232 can be configured to instruct switch 1223 to turn-off charging station 700 using switch 1223 when sensors 1228, 1229, 1230, and 1231 detects that no electrical power is being drawn by the one or more portable electronic devices. Controller 1232 can include a microprocessor electrically coupled to sensors 1228, 1229, 1230, and 1231 and switch 1223 such that the microprocessor turns on or turns off switch 1223 based on the electrical status of the one or more output power couplings. In one example, controller 1232 can be an 8-bit microcontroller manufactured by Elan Microelectronics Corporation with a part number of EM78P124N.

In some examples, controller 1232 can include timer 1233. In other examples, timer 1233 is separate from controller 1232 or is not part of circuitry 1220. In some examples, timer 1233 can be configured to track a charging time that the one or more electronic devices are drawing electrical power from charging station 700. In various embodiments, controller 1232 is configured to turn-off output ports 824, 825, 826, and 827 after timer 1233 tracks that the one or more electronic devices have been drawing electrical power for at least a predetermined period of time. For example, the predetermined period of time can be one to four hours. In various embodiments, timer 1233 can track the charging time by counting down from the predetermined period of time to zero. In other examples, timer 1233 can track the charging time by counting up from zero.

In some examples, timer 1233 can be configured to reset the charging time when at least one of sensors 1228, 1229, 1230, and 1231 detects that a new electronic device has been coupled to one of output ports 824, 825, 826, and 827. When timer 1233 is configured to count up to the predetermined amount of time, the timer can be reset to zero. When timer 1233 is configured to count down from the predetermined amount of time, the timer can be reset to the predetermined amount of time.

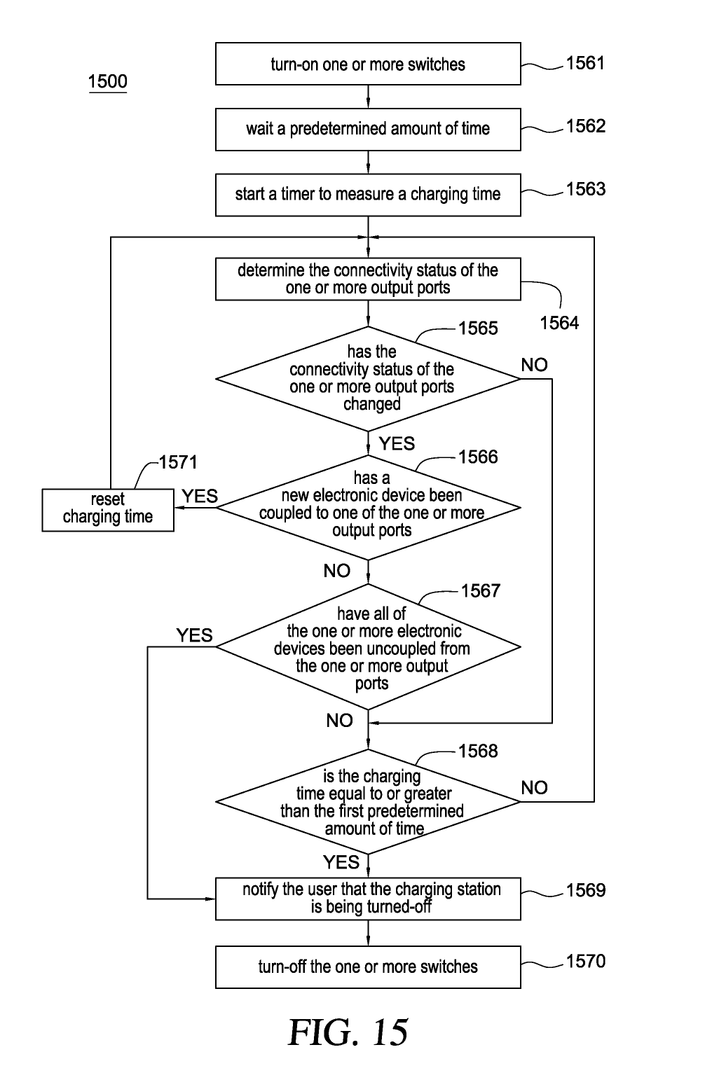

One way electrical power is wasted by traditional charging stations is that these traditional charging stations will continue to provide electrical power to fully-charged electronic devices for an infinite period of time after the electronic devices are already fully charged. Charging station 700 and method 1500 (FIG. 15) conserve electrical power by not providing electrical power to already fully-charged electronic devices. Most electronic device can be fully-charged in a short period of time. If the charging station stops providing electrical power to the electronic devices after the short time it takes to charge most electronic devices, the electronic devices can be fully charged and electrical power can also be conserved. In some examples, controller 1232 can turn-off charging station 700, a predetermined time period after the last electronic device was coupled to one of the output ports to conserve electrical power and to avoid charging fully-charged electronic devices.

Display 734 can be electrically coupled to controller 1232 and configured to display information regarding charging station 700 to a user. In some examples, display 734 can be one or more light emitting diodes (LEDs). In one example, when display 734 is an LED, the LED can be illuminated when charging station 700 is charging one or more electronic devices and flash three times before charging station 700 is turned-off. In other examples, display 734 can be a liquid crystal display (LCD) or another type of display.

The circuitry in FIGS. 13 and 14 includes reference numbers in parentheses, which indicate the elements with the same reference numbers in FIG. 12.

FIG. 15 illustrates a flow chart for an embodiment of a method 1500 of providing electrical power to one or more electronic devices using a charging station when the one or more electronic devices are electrically coupled to one or more output ports of the charging station. Method 1500 is merely exemplary and is not limited to the embodiments presented herein. Method 1500 can be employed in many different embodiments or examples not specifically depicted or described herein

As an example, the charging station can be similar or identical to charging station 700 of FIG. 7. The one or more ports can be similar or identical to output ports 824, 825, 826, and 827 of FIGS. 8 and 12.

Referring to FIG. 15, method 1500 includes an activity 1561 of turning-on one or more switches. Turning-on the one or more switches can begin providing electrical power to the one or more output ports. In some examples, the charging station is turned-on by pressing a button (i.e., the switch). In some examples, the switch can be similar or identical to switch 722 of FIG. 7. In same or different examples, switching switch 722 can cause one or more additional switches (e.g., switch 1223 (FIG. 12)) to be turned-on. Switch 722 can be a non-latching switch, and switch 1223 can be a latching switch.

In some examples, a user can push a non-latching switch (e.g., switch 722) to turn-on the charging station. While the user is holding down the non-latching switch, electrical power flows through the non-latching switch into the rest of circuitry of the charging station including an internal power supply (e.g., internal power supply 1221). The internal power supply initiates a controller (e.g., controller 1232), and the controller turns on a latching switch (e.g., switch 1223). When the user releases the non-latching switch, the non-latching switch is opened but electricity continues to flow through the latching switch to the rest of circuitry of the charging station. In some examples, the user is considered to turn-on the non-latching switch, and the charging station is considered to turn-on the latching switch.

Next, method 1500 can include an activity 1562 of waiting a predetermined amount of time. In some examples, a timer 1233 can measure the predetermined amount of time. Charging station 700 can wait the predetermined amount of time to allow all of the elements of charging station 700 to be initialized and charging station 700 to begin charging any electronic devices coupled to the one or more output ports. In various embodiments, the predetermined amount of time can be one minute. In other embodiments, other predetermined amounts of time can be used.

Method 1500 can continue with an activity 1563 of starting a timer to measure a charging time. Charging time can be measured to allow charging station 700 to stop providing electrical power to the electronic device coupled to the output ports after a predetermined amount of time has passed. In some examples, the timer can measure the charging time from counting down from a first predetermined amount of time (e.g., three hours) to zero. In other examples, the timer can measure the charging time by counting up from zero.

Subsequently, method 1500 can include an activity 1564 of determining the connectivity status of the one or more output ports. In some examples, one or more sensors can determine the electrical status of the one or more output ports and report the status to the controller. In some examples, the one or more sensor can be similar or identical to sensors 1228, 1229, 1230, and 1231 (FIG. 12). The controller can be similar or identical to controller 1232 (FIG. 12). For example, each of the one or more sensors 1228, 1229, 1230, and 1231 can be configured to detect the following connectivity statuses: (a) no-power drawings status; (b) an active-power drawing status; and (c) no-device connected status.

In some examples, the controller can keep track of the connectivity status of the output ports in some embodiments. For example, the controller can keep track of the number of output ports that have an electronic device coupled to the output port, where the electronic device is drawing electrical power. In other examples, the controller can individually track the status of each of the output ports. In still other examples, the controller can track how many of the output ports have a no-power drawings status, an active-power drawing status, and/or a no-device connected status.

Subsequently, method 1500 can include an activity 1565 of determining whether the connectivity status of the one or more output ports has changed. In activity 1566, the controller can poll the one or more sensors to check the connectivity status. In other examples, the one or more sensors can communicate changes in connectivity status to the microcontroller. If the connectivity status of the one or more ports has not changed, the next activity is an activity 1568.

If the connectivity status has changed, the next activity in method 1500 is an activity 1566 of determining whether a new electronic device has been coupled to one of the one or more output ports.

If a new electronic device has been coupled to one of the one or more output ports, the next activity in method 1500 is an activity 1571 of resetting the charging time. When the charging time is being measured by counting up from zero to a first predetermined amount of time (e.g., three hours), the charging time can be reset to zero. When the charging time is being measured by counting down from the first predetermined amount of time to zero, the timer can be reset to the first predetermined amount of time.

The charging time can be reset to allow the new electronic devices to be fully charged before the charging station turns off and stops providing electrical power to the one or more electronic devices. If the charging time was not reset, the charging station might only provide electrical power to the new electronic device for a very short period of time (and thus, not fully charge the new electronic device) before the charging station turns off. After activity 1571, the next activity is activity 1564.

If no new electronic devices have been coupled to the one or more output ports, as determined by activity 1566, the next activity in method 1500 is an activity 1567 of determining if all of the one or more electronic devices have been uncoupled from the one or more output ports.

In some embodiments, the controller can determine if all of the one or more electronic devices have been uncoupled from the one or more output ports. For example, the controller can keep track of how many electronic devices are coupled to the charging station. If all of the electronic devices have been uncoupled from the charging station, there is no need for the charging station to be turned-on and drawing electrical power from the external electrical power source. Accordingly, if all of the electronic devices are uncoupled from the charging station, the charging station is turned-off to conserve electrical power. That is, the next activity in method 1500 is an activity 1569 if all of the one or more electronic devices have been uncoupled from the one or more output ports. If one or more electronic devices are still coupled to the one or more output ports, however, the next activity in method 1500 is activity 1568.

If one or more electronic device are still coupled to the one or more output ports, method 1500 includes an activity 1568 of determining whether the charging time is equal to or greater than the first predetermined amount of time. If the charging time is being measured by counting down from the first predetermined amount of time to zero, activity 1568 determines if the measured time is equal to or less than zero. If the charging time is being measured by counting up from zero to the first predetermined time, activity 1568 determines if the measured time is equal to or greater than the first predetermined amount of time.

If the charging time is equal to or greater than the first predetermined amount of time, the next activity in method 1500 is activity 1569. If the charging time is less than the first predetermined amount of time, the next activity in method 1500 is activity 1564.

Activity 1569 in method 1500 includes notifying the user that the charging station is being turned-off. In some examples, display 734 can be used to notify a user that the charging station is being turn-off.

After activity 1569, method 1500 can continue with an activity 1570 of turning-off the one or more switches such that the charging station is not using any electrical power. In some examples, the controller can turn-off one or more switches (e.g., switch 1223) to turn-off the charging station such that the charging station is not using any electrical power.

Although the embodiments have been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the charging station discussed herein may be implemented in a variety of embodiments, and that the foregoing discussion of certain of these embodiments does not necessarily represent a complete description of all possible embodiments. In particular, among other variations, a single sensor can be used for all output ports.

Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A charging station configured to provide electrical power to one or more portable electronic devices, the charging station comprising:
at least one switch configured to turn-on and turn-off the charging station such that the charging station is not drawing any of the electrical power when the charging station is turned-off;
one or more output ports configured to supply the electrical power to the one or more portable electronic devices when the one or more portable electronic devices are electrically coupled to the one or more output ports and the charging station is turned-on;
one or more sensors electrically coupled to the one or more ports and configured to detect whether the electrical power is being drawn by the one or more portable electronic devices through the one or more output ports; and
a controller module configured to turn-off the charging station using the at least one switch when the one or more sensors detect that the electrical power is not being drawn by the one or more portable electronic devices through the one or more output ports.

2. The charging station of claim 1, wherein:
a first switch of the at least one switch is configured to allow a user to turn-on the charging station;
a second switch of the at least one switch electrically coupled to the controller and the first switch of the at least one switch;
the second switch of the at least one switch is configured to turn-off the charging station when instructed by the controller to turn-off the charging station such that the charging station is not drawing any electrical power when the charging station is turned-off;
the first switch of the at least one switch is a non-latching switch; and
the second switch of the at least one switch is a latching switch.

3. The charging station of claim 1, wherein:
the at least one switch is electrically coupled to the one or more output ports, the controller, and the one or more sensors such that the at least one switch must be turned-on for the one or more output ports, the controller, and the one or more sensors to receive electrical power.

4. The charging station of claim 1, wherein:
each of the one or more sensors comprises:
a sensing resistor; and
an operational amplifier electrically coupled to the sensing resistor.

5. The charging station of claim 1, further comprising:
an internal power supply configured to convert alternating current electrical power into direct current electrical power,
wherein:
the electrical power comprises the alternating current electrical power and the direct current electrical power.

6. The charging station of claim 1, further comprising:
an input connector configured to receive electrical power from one or more external power sources.

7. The charging station of claim 1, wherein:
the one or more output ports comprise universal serial bus ports.

8. The charging station of claim 1, wherein:
the at least one switch comprises a push-button switch.

9. The charging station of claim 1, wherein:
the controller comprises:
a timer configured to track a time that the one or more portable electronic devices are drawing electrical power through the one or more output ports.

10. The charging station of claim 9, wherein:
the controller is configured to turn-off the charging station after the timer tracks that the one or more portable electronic devices have been drawing electrical power through the one or more output ports for at least a predetermined period of time.

11. The charging station of claim 9, wherein:
the one or more sensors are further configured to detect when a first device of the one or more portable electronic devices is coupled to the one or more output ports.

12. The charging station of claim 11, wherein:
the timer is configured to reset the time that the one or more portable electronic devices are drawing electrical power when the one or more sensors detect the first device of the one or more portable electronic devices is coupled to the one more output ports.

13. The charging station of claim 1, further comprising:
a base configured to rest on a surface;
a coupling region coupled to the base; and
a tray coupled to the coupling region,
wherein:
the tray comprises a surface for receiving the one or more portable electronic devices;
the one or more portable electronic devices comprise a charger cord;
the coupling region is configured to have the charger cord of the one or more portable electronic devices wrapped around the coupling region.

14. The charging station of claim 13, wherein:
the coupling region has a cavity; and
at least one of the controller, the at least one switch, or the one or more sensors are located in the cavity.

15. The charging station of claim 13, wherein:
the one or more output ports are located at the base; and
a first switch of the at least one switch is located at the tray.

16. A charge valet configured to charge two or more portable electronic devices, the charge valet comprising:
an input power coupling configured to receive alternating current electrical power from one or more external electrical power sources;
one or more switches electrically coupled to the input power coupling such that the charge valet is not pulling any of the alternating current electrical power from the one or more external electrical power sources when the one or more switches is turned-off;
an electrical power converter electrically coupled to the one or more switches and configured to convert the alternating current electrical power to direct current electrical power;
one or more output power couplings electrically coupled to the electrical power converter and configured to provide the direct current electrical power to the two or more portable electronic devices;
one or more sensor units electrically coupled to the electrical power converter and the one or more output power couplings such that the one or more sensor units detect an electrical status of the one or more output power couplings; and
a microprocessor electrically coupled to the one or more sensor units and the at least one of the one or more switches such that the microprocessor turns-off at least one of the one or more switches based on the electrical status of the one or more output power couplings.

17. The charge valet of claim 16, wherein:
each of the one or more sensor units is electrically coupled to a different one of the one or more output power couplings;
each of the one or more sensor units is configured to detect no-power drawings status and an active-power drawing status of the different one of the one or more output power couplings; and
the electrical status of the one or more output power couplings comprise the no-power drawing status and the active-power drawing status.

18. The charge valet of claim 16, wherein:
the one or more output power couplings are electrically coupled to the electrical power converter through the one or more sensor units.

19. The charge valet of claim 16, further comprising:
a display electrically coupled to the microprocessor and configured to display information regarding the charge valet to a user.

20. The charge valet of claim 16, further comprising:
a timer electrically coupled to the one or more sensor units and configured to track an amount of time that the two or more portable electronic devices are drawing direct current electrical power from the one or more output power couplings.

21. The charge valet of claim 20, wherein:
the microprocessor comprises the timer.

22. A method of providing electrical power to one or more portable electronic devices using a charging station when the one or more portable electronic devices are electrically coupled to one or more output ports of the charging station, the method comprising:
turning-on one or more switches to begin providing electrical power to the one or more output ports of the charging station;
determining a connectivity status of the one or more output ports of the charging station;
determining a change in the connectivity status of the one or more output ports of the charging station; and
if the change in the connectivity status of the one or more output ports of the charging station is that all of the one or more portable electronic devices have been uncoupled from the one or more output ports of the charging station, turning-off at least one of the one or more switches such that the charging station is not using any electrical power.

23. The method of claim 22, further comprising:
starting a timer to track a charging time;
if the charging time is equal to or greater than a first predetermined amount of time, turning-off the at least one of the one or more switches such that the charging station is not using any electrical power; and
if the change in the connectivity status of the one or more ports of the charging station is that a new electronic device of the one or more portable electronic devices has been coupled to one of the one or more output ports of the charging station, resetting the charging time.

24. The method of claim 23, further comprising:
before starting the timer, waiting a second predetermined amount of time.

25. The method of claim 22, further comprising:
before turning-off the at least one of the one or more switches, notifying the user that the charging station is being turned-off.
